(19) United States
(12) Patent Application Publication
(10) Pub. No.: US 2026/0055012 A1
(43) Pub. Date: Feb. 26, 2026

(54) ZINC ION WATER TREATMENT DEVICE

(71) Applicants: Hak-Sub SHIM, Seoul (KR); Jinhaeng waterway Co., Ltd., Anseong-si (KR)

(72) Inventor: Hak-Sub SHIM, Seoul (KR)

(73) Assignees: Hak-Sub SHIM, Seoul (KR); Jinhaeng waterway Co., Ltd., Anseong-si (KR)

(21) Appl. No.: 19/293,686

(22) Filed: Aug. 7, 2025

(30) Foreign Application Priority Data
Aug. 20, 2024 (KR) 10-2024-0110874

(51) Int. Cl. C02F 1/42

(52) U.S. Cl. CPC C02F 1/42; C02F 2001/422; C02F 2001/425

(57) ABSTRACT

A zinc ion water treatment device in which a plurality of fluorine resin bodies is installed at regular intervals within a housing and a zinc block body is disposed between the fluorine resin bodies, in which the fluorine resin body and the zinc block body are provided with a plurality of flow channels through which the fluid flows, the flow channel provided in the fluorine resin body or the flow channel provided in the zinc block body or the flow channels provided in the fluorine resin body and the zinc block body include an inlet through which a fluid is introduced, an outlet through which the fluid is discharged, and a flow hole connecting the inlet and the outlet, and the inlet is formed as an expansion pipe portion whose diameter (inner diameter) gradually expands in a direction of an outside (A) from the flow hole, the outlet is formed as a reduction pipe portion whose diameter (inner diameter) gradually decreases in a direction of the flow hole from the outside (A), and the outlet or the inlet or the outlet and the inlet are provided with one or more eddy current-inducing grooves on a surface, so that when the fluid passes through the flow channel, eddy current generation is increased by the inlet and/or the outlet provided with the eddy current-inducing grooves.

### CROSS-REFERENCE TO RELATED APPLICATIONS

This application claims the priority of Korean Patent Application No. 10-2024-0110874 filed on Aug. 20, 2024, in the Korean Intellectual Property Office, the disclosure of which is incorporated herein by reference.

### BACKGROUND

### Field

The present disclosure relates to a zinc ion water treatment device, and relates to a zinc ion water treatment device that enhances the generation of eddy currents in a fluid to enhance the binding force of static electricity and zinc ions.

### Description of the Related Art

Recently, an ion water treatment device called a scale booster has been used to remove or prevent scale or rust in a pipe through which a fluid flows. As illustrated in FIG. 1, a conventional ion water treatment device has a zinc block forming a sacrificial anode inside a brass body (housing) and a fluorine resin block that generates a potential electrostatic charge using the flow of a fluid to induce precipitation of harmful substances contained in the fluid, thereby extending the life of old pipes and improving water quality by utilizing the sacrificial anode method of the zinc block.

The above ion water treatment device is installed between two adjacent pipes as an independent unit, and flanges are formed at both ends of the ion water treatment device for connection with the pipes. For example, in Korean Patent Application No. 10-2009-0114907, flanges provided at both ends of the ion water treatment device are configured to be rotatable, thereby making it easier to align the fastening holes between the flanges, thereby introducing an ion water treatment device having a rotatable flange for easy installation of the ion water treatment device.

In general, the ion water treatment device exhibits the effect of preventing corrosion and removing scale in the pipe by releasing zinc ions into the water due to a potential difference between the brass which is an external housing and a zinc plate. However, since there are not many metals that can generate a potential difference with zinc, a method for effectively increasing the amount of zinc ions generated is required.

### SUMMARY

An object of the present disclosure is to provide a zinc ion water treatment device that promotes zinc ionization by improving the generation of eddy currents in a fluorine resin body and a zinc block body, thereby improving the efficiency of static electricity generation.

Another object of the present disclosure is to provide a zinc ion water treatment device that can facilitate zinc ionization and enhance a bonding force with scale particles in the fluid by inducing an eddy current to increase a frictional force with a fluorine resin during the process of the fluid passing through a fluorine resin plate and maximizing the amount of static electricity generated.

The present disclosure provides a zinc ion water treatment device in which a plurality of fluorine resin bodies is installed at regular intervals within a housing and a zinc block body is disposed between the fluorine resin bodies, in which the fluorine resin body and the zinc block body are provided with a plurality of flow channels through which the fluid flows, the flow channel provided in the fluorine resin body or the flow channel provided in the zinc block body or the flow channels provided in the fluorine resin body and the zinc block body include an inlet through which a fluid is introduced, an outlet through which the fluid is discharged, and a flow hole connecting the inlet and the outlet, and the inlet is formed as an expansion pipe portion whose diameter (inner diameter) gradually expands in a direction of an outside (A) from the flow hole, the outlet is formed as a reduction pipe portion whose diameter (inner diameter) gradually decreases in a direction of the flow hole from the outside (A), and the outlet or the inlet or the outlet and the inlet are provided with one or more eddy current-inducing grooves on a surface, so that when the fluid passes through the flow channel, eddy current generation is increased by the inlet and/or the outlet provided with the eddy current-inducing grooves.

According to the present disclosure, the fluorine resin body and the zinc block body are combined in the housing made of stainless steel (SUS), and the amount of zinc ions dissolved increases according to the potential difference between the housing and the zinc block body.

According to the present disclosure, the flow channel of the fluorine resin body and the zinc block body installed in the housing has the outlet formed as the expansion pipe portion and the inlet formed as the reduction pipe portion, and one or more eddy current-inducing grooves that induce the eddy current are formed in the outlet and the inlet. Therefore, the fluid supplied into the flow channel collides with the eddy current-inducing groove and the surfaces of the outlet and inlet provided with the eddy current-inducing grooves, thereby generating an effect of continuously generating eddy currents.

According to the present disclosure, the frictional force between the fluorine resin body and the fluid is increased by the eddy current-inducing grooves, thereby maximizing the electrostatic effect, and accordingly, the ionization of zinc is easily achieved, thereby having the effect of smoothly combining with scale (inorganic matter) particles in the fluid.

According to the present disclosure, the flow channel provided in the fluorine resin body and the zinc block body is provided to have a venturi tube shape. Therefore, static electricity generation and zinc ionization are maintained at a constant level by the change in fluid flow rate and the increase in friction, and thus corrosion, scale, and water stains in the pipe can be effectively prevented.

According to the present disclosure, the fluid inflow space and fluid outflow space are provided in the fluorine resin body and the zinc block body, and the outlet/inlet of the flow channel connected to the fluid inflow space and the fluid outflow space is formed as an expanded tube structure, and the eddy current-inducing groove is provided, so that the fluid flows (eddy current generation) in the flow channel close to the housing and the zinc block body, so that a large amount of zinc ions are eluted, and thus corrosion and scale removal effects in the pipe are improved, and so on, and there are many other effects.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exemplary view illustrating a configuration according to the present disclosure;

FIGS. 2A to 2C are exemplary views illustrating a configuration of a fluorine resin body according to the present disclosure;

FIGS. 3A to 3C are exemplary views illustrating a configuration of a zinc block body according to the present disclosure;

FIGS. 4A and 4B are other exemplary views illustrating the configurations of the fluorine resin body and the zinc block body according to the present disclosure;

FIG. 5 is an exemplary view illustrating a configuration of a flow channel according to the present disclosure;

FIG. 6 is another exemplary view illustrating the configuration of the flow channel according to the present disclosure;

FIGS. 7A to 7C are exemplary views illustrating a configuration of an eddy current-inducing groove according to the present disclosure;

FIGS. 8A to 10B are exemplary views illustrating the arrangement of the eddy current-inducing grooves according to the present disclosure and the flow of fluid thereby;

FIGS. 11A and 11B are exemplary views illustrating the configurations of the fluorine resin body and the zinc block body (exemplary views illustrating a configuration equipped with a flow channel without the eddy current-inducing groove) according to the present disclosure; and

FIG. 12A and FIG. 12B are exemplary views illustrating a combined state of a zinc ion water treatment device according to the present disclosure.

### DETAILED DESCRIPTION OF THE EMBODIMENT

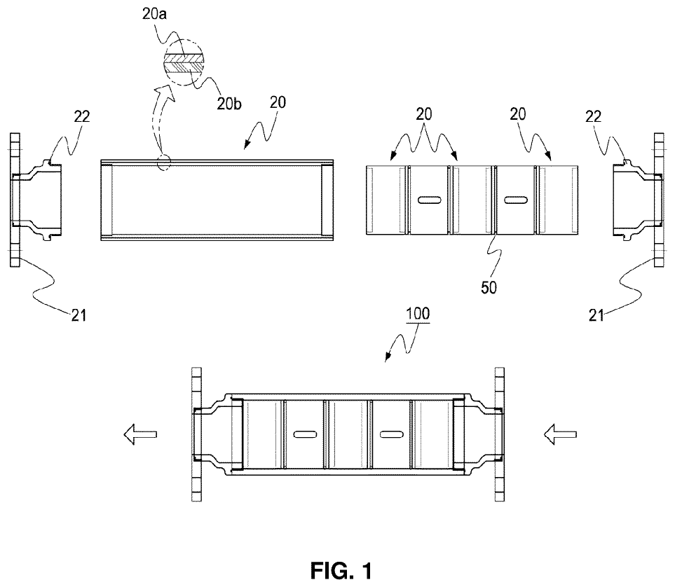

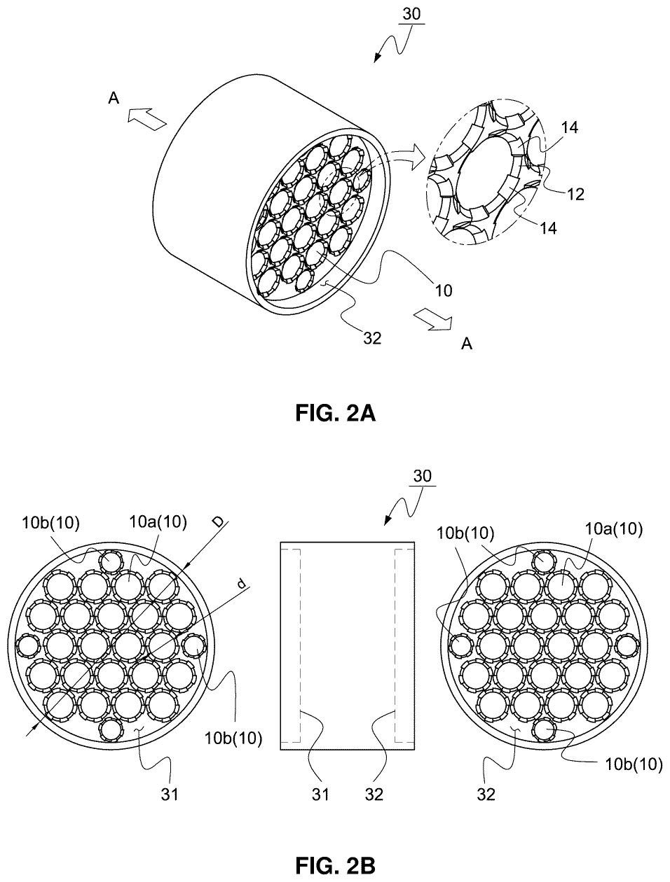

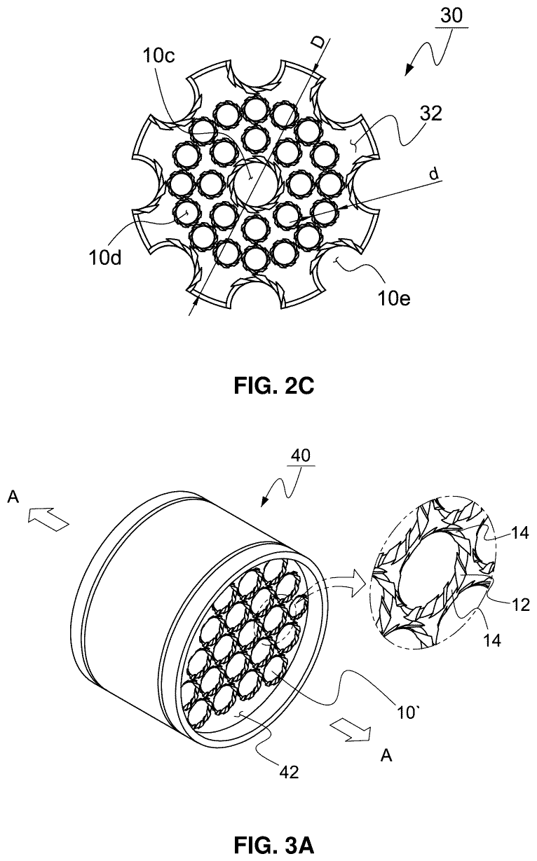

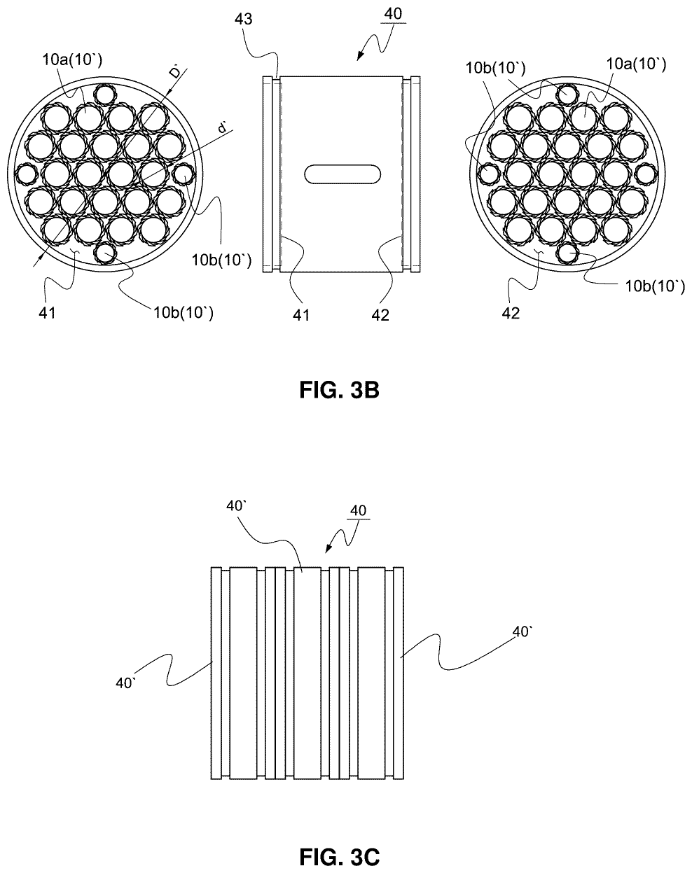

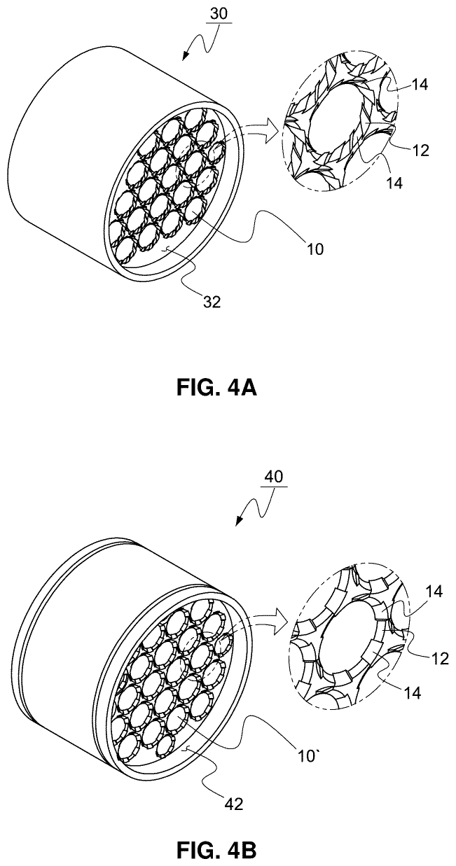

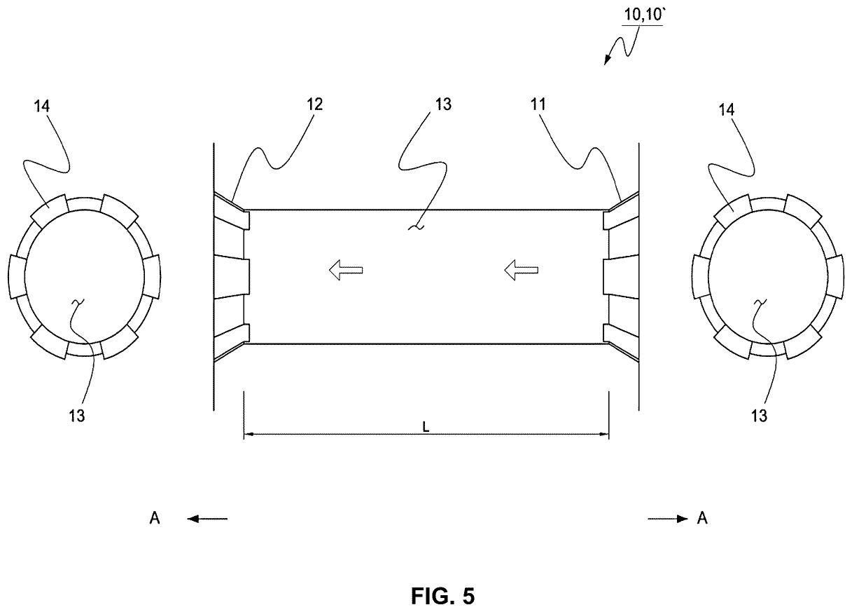

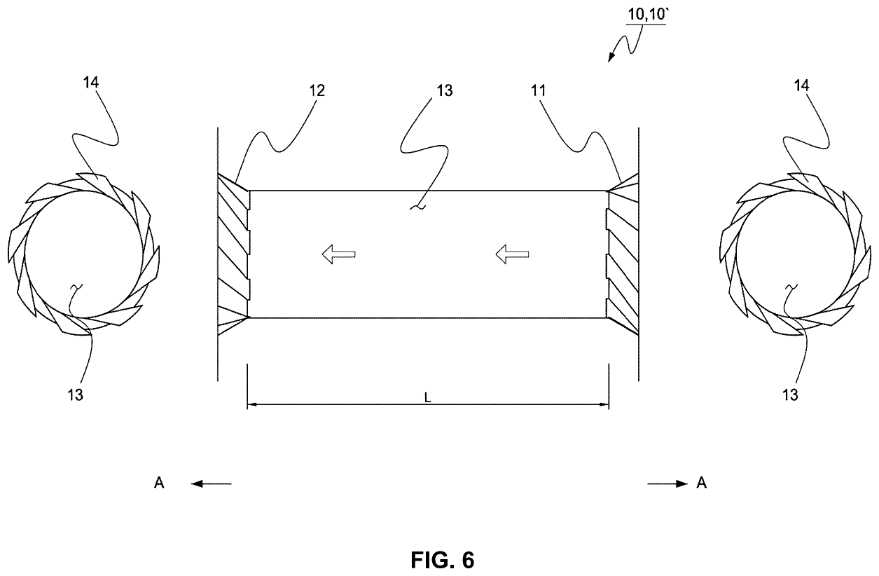

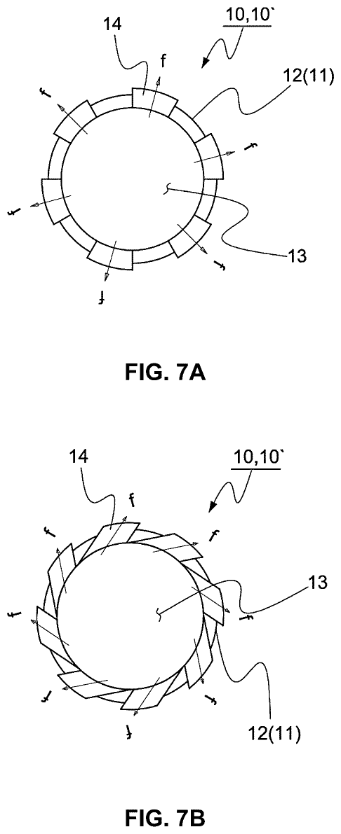

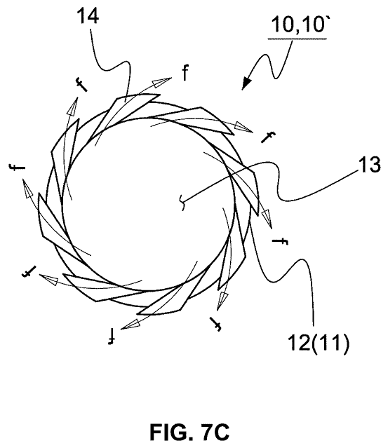

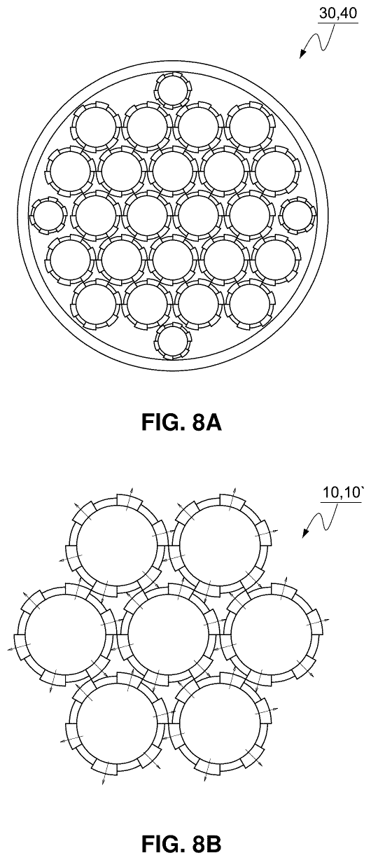

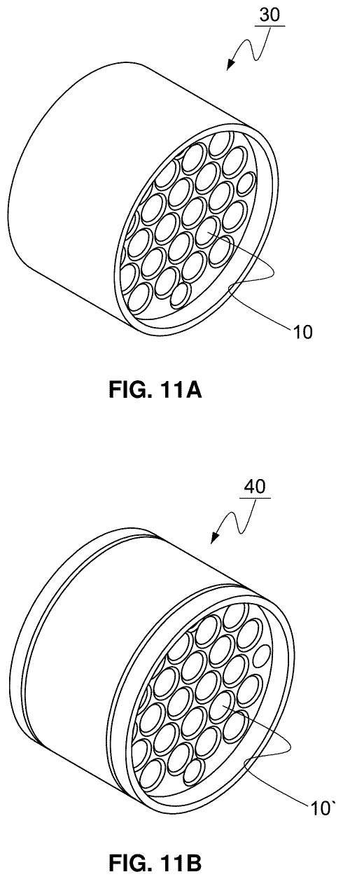

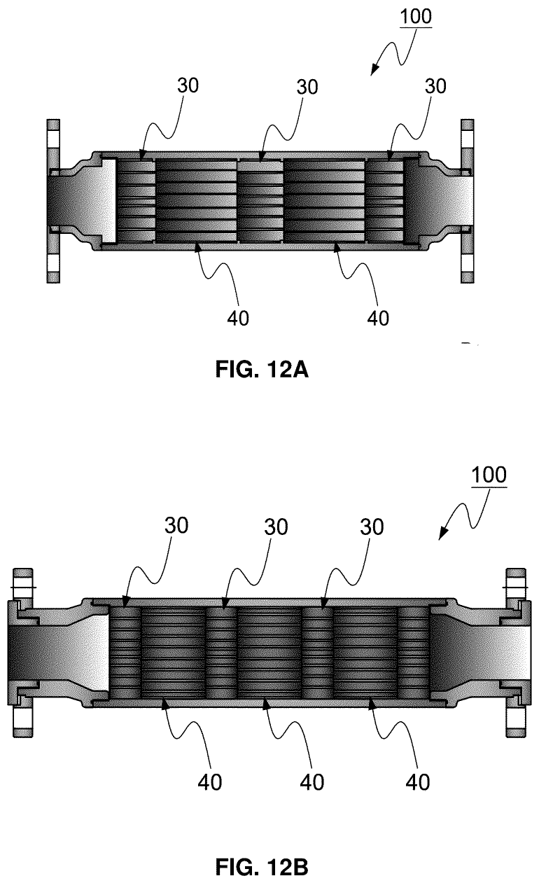

Hereinafter, FIG. 1 is an exemplary view illustrating a configuration according to the present disclosure, FIGS. 2A to 2C are exemplary views illustrating a configuration of a fluorine resin body according to the present disclosure, FIGS. 3A to 3C are exemplary views illustrating a configuration of a zinc block body according to the present disclosure, FIGS. 4A and 4B are other exemplary views illustrating the configurations of the fluorine resin body and the zinc block body according to the present disclosure, FIG. 5 is an exemplary view illustrating a configuration of a flow channel according to the present disclosure, FIG. 6 is another exemplary view illustrating the configuration of the flow channel according to the present disclosure, FIGS. 7A to 7C are exemplary views illustrating a configuration of an eddy current-inducing groove according to the present disclosure, FIGS. 8A to 10B are exemplary views illustrating the arrangement of the eddy current-inducing grooves according to the present disclosure and the flow of fluid thereby, FIGS. 11A and 11B are exemplary views illustrating the configurations of the fluorine resin body and the zinc block body (exemplary views illustrating a configuration equipped with a flow channel without the eddy current-inducing groove) according to the present disclosure, and FIG. 12A and FIG. 12B are exemplary views illustrating a combined state of a zinc ion water treatment device according to the present disclosure.

The present disclosure relates to an ion water treatment device 100 in which a plurality of fluorine resin bodies 30 is installed at regular intervals in a housing 20 and a zinc block body 40 is disposed between the fluorine resin bodies 30.

The fluorine resin body 30 and the zinc block body 40 are equipped with a plurality of flow channels 10 and 10′ through which the fluid flow occurs.

The flow channel 10 of the fluorine resin body or the flow channel 10′ of the zinc block body or the flow channels 10 and 10′ of the fluorine resin body and the zinc block body include an inlet 11 through which a fluid is introduced, an outlet 12 through which fluid is discharged, and a flow hole 13 connecting the inlet and the outlet.

The inlet 11 is formed as an expansion pipe portion whose diameter (inner diameter) gradually expands in a direction of an outside A from the flow hole 13, and the outlet 12 is formed as a reduction pipe portion whose diameter (inner diameter) gradually decreases in a direction of the flow hole 13 from the outside A from the flow hole 13, and the outlet 12 or the inlet 11 or the outlet 12 and the inlet 11 are provided with one or more eddy current-inducing grooves 14 on a surface, so that when the fluid passes through the flow channel 10, the eddy current generation is increased by the inlet 11 and/or the outlet 12 provided with the eddy current-inducing grooves 14.

The housing 20 is formed as a cylindrical pipe, and flanges 21 are connected to both ends. For example, the housing 20 may be configured such that caps 22 are installed at both ends, as illustrated in FIG. 1, and the flange 21 is connected to the cap 22.

In addition, the cap 22 may be configured such that one end is screw-connected to the housing 20 and the other end is inserted and connected to the flange 21, and the flange 21 may be formed as a rotatable flange. Since the rotatable flange is a known technology, a detailed description thereof will be omitted.

The housing 20 may be formed as a single-tube structure made of stainless steel (SUS), brass, copper, a binary alloy of copper and tin, iron, or the like, or a heterogeneous composite tube structure using these, and it is preferable that the housing is formed as a heterogeneous composite tube structure in which the outer side is made of brass and the inner side is made of stainless steel (SUS).

In this case, the brass material and stainless steel (SUS) material may be made to have a thickness ratio of 1:0.5 to 1.5.

In addition, the stainless steel (SUS) material may be SUS 304, SUS 404, SUS 316, or the like.

In this way, the housing made of stainless steel (SUS) material has the effect of increasing the amount of zinc ion elution depending on the potential difference with the zinc block body.

For example, as illustrated in FIG. 1, when comparing a housing 20 having a heterogeneous composite tube structure (thickness ratio 1:1) in which an inner housing (20b) made of stainless steel (SUS 304) is provided within an outer housing (20a) made of brass, and a housing having a single tube structure made of brass, as illustrated in [Table 1] to [Table 3] below, not only is there a large difference in potential difference, but it can also be seen that an average zinc ion release amount increases by about 1.4 times.

TABLE 1

| | | Number of | | | | | Potential |
|---|---|---|---|---|---|---|---|
| | | electrons | | | Potential | | difference |
| Ion | | emitted | | Matel | difference | Content | calculation |
| Zn2+ | + | 2e− | > | Zn | −0.763 | 100% | −0.5554 |
| Ni2+ | + | 2e− | > | Ni | −0.25 | 10% | −0.025 |
| Cr2+ | + | 2e− | > | Cr | −0.913 | 20% | −0.1826 |

♦ Conclusion: 0.55 V

TABLE 2

| | | Number of | | | | | Potential |
|---|---|---|---|---|---|---|---|
| | | electrons | | | Potential | | difference |
| Ion | | emitted | | Matel | difference | Content | calculation |
| Zn2+ | + | 2e− | > | Zn | −0.76 | 100% | −0.385 |
| Zn2+ | + | 2e− | > | Zn | −0.76 | 65% | −0.494 |
| Cu+ | + | 2e− | > | Cu | 0.34 | 35% | 0.119 |
| [symbol] | | | | | | | −0.375 |

♦ Conclusion: 0.39 V

TABLE 3

| | Time | | | |
|---|---|---|---|---|
| | 10 Minute | 30 Minute | 60 Minute | Average |
| Double composite housing | 0.94 | 1.15 | 1.25 | 1.11 |
| [Zn (ppm)] | | | | |
| Brass housing | 0.54 | 0.81 | 0.91 | 0.75 |
| [Zn (ppm)] | | | | |

[Table 1] illustrates the potential difference for a double composite housing having an inner housing made of stainless steel (SUS 304), [Table 2] illustrates a potential difference for a housing made of brass, and [Table 3] illustrates a zinc ion release amount according to this.

In addition, the housing 20 may be further coated with a corrosion inhibitor on the surface to prevent corrosion, and the corrosion inhibitor may be made of a fluorine (F) material or a combination of zinc (Zn) and aluminum (Al).

As illustrated in FIGS. 2A to 2C, FIGS. 12A and 12B, the fluorine resin bodies 30 are installed to be spaced apart at regular intervals inside the housing 20 and generate static electricity by friction with the fluid, and have the plurality of flow channels 10 through which the fluid flows.

The static electricity generated in the fluorine resin body 30 is charged to the ionic substance in the fluid, and quickly and strongly combines the zinc ions (Zn²₊) generated by the zinc plate of the zinc assembly with the fluid ionic substances, such as corrosion factors, scales, and water stain factors, thereby relatively increasing the carbonate ions in the fluid, thereby effectively removing the scale attached to the pipe.

As illustrated in FIGS. 2A to 2C, the fluorine resin body 30 is provided with a fluid inflow space 31 on one side and a fluid outflow space 32 on the other side with the flow channel 10 as the center, and may be configured such that the fluid inflow space 31 and the fluid outflow space 32 are connected to each other by the flow channel 10.

The fluid inflow space 31 is a place where the fluid is introduced, and has a function of ensuring that the fluid is introduced uniformly into the flow channel 10 of the fluorine resin body.

In addition, the fluid inflow space 31 is provided with a function of compensating for the pressure of the fluid that has increased while passing through the flow channel 10′ of the zinc block body when the fluorine resin body 30 is placed between the zinc block bodies 40 so that the fluid pressure is homogenized, and a function of generating an eddy current in the fluid that has passed through the flow channel 10′ of the zinc block body so that the friction efficiency with the fluorine resin body 30 is increased.

The fluid outflow space 32 is where the fluid that has passed through the flow channel 10 of the fluorine resin body is introduced, and has a function of compensating for the pressure of the fluid that has increased while passing through the flow channel 10′ so that the fluid pressure is homogenized, so that the fluid is uniformly introduced into the flow channel 10′ of the zinc block body, and at the same time generating an eddy current in the fluid that has passed through the flow channel 10 of the fluorine resin body so that the combination of zinc ions and ionic substances in the fluid is efficiently performed.

The flow channel 10 is formed so that a plurality of flow channels is evenly arranged through the fluorine resin body 30, and may be formed so that the flow channels all have the same inner diameter, or formed so that the flow channels have two inner diameters, or formed so that the flow channels have different inner diameters.

In addition, it is preferable that a plurality of flow channels 10 is formed so that the flow channel has the volume ratio of about 1:0.4 to 0.6 with respect to the entire volume of the fluorine resin body, and an inner diameter (d) of 0.08 (D) to 0.25 (D) with respect to a diameter (D) of the fluorine resin body. For example, the flow channel 10 may be formed in the range of about 20 to 30 in the fluorine resin body.

That is, when the volume ratio of the flow channel to the fluorine resin body is out of 1:0.4 to 0.6, not only will the fluid flow and friction with the fluid decrease, but the rigidity of the fluorine resin body may also decrease. Accordingly, it is desirable that the flow channel is formed within an appropriate range.

In addition, when the flow channel 10 is formed to exceed 0.25 (D), the flow rate decreases and the friction with the fluid decreases, which reduces the amount of static electricity generated, and when the flow channel is formed to be less than 0.08 (D), the number of flow channels increases, which not only has a negative effect on the flow of the fluid, but also reduces the amount of static electricity generated.

As described above, the fluorine resin body 30 according to the present disclosure is designed to ensure smooth fluid flow by limiting the inner diameter and volume ratio of the flow channel 10, while efficiently generating static electricity by friction between the fluorine resin body 30 and the fluid.

As an example, FIGS. 2A and 2B illustrate a configuration in which 22 first flow channels 10a having an inner diameter (ϕ11) are formed in a plurality of rows within the fluorine resin body 30 having a diameter (ϕ85) such that the fluorine resin body 30 and the flow channel have a volume ratio of about 1:0.45 to 0.48, and 4 flow channels 10b having an inner diameter (ϕ9) are formed in accordance with the rows of the first flow channel 10a. In this case, the first inner diameter and the second inner diameter refer to the inner diameters of the flow holes 13 within the flow channels.

In addition, FIG. 2C of the present disclosure illustrates a configuration in which a third flow channel 10c having an inner diameter (ϕ15), 24 fourth flow channels 10d having an inner diameter (ϕ8), and 8 semicircular fifth flow channels 10e having an inner diameter (20) are arranged in a circular manner so as to have a multi-layer structure in the radial direction within the fluorine resin body 30 having a diameter (ϕ82) such that the fluorine resin body 30 and the flow channel have a volume ratio of about 1:0.45 to 0.48. The fluorine resin body 30 configured in this manner has the effect of improving the generation of static electricity by increasing friction with the fluid due to the eddy currents while allowing the fluid to flow smoothly.

In addition, the fluorine resin body 30 configured as described above may be made of a fluorine-containing material, for example, polytetrafluoroethylene (PTFE), so that static electricity is smoothly generated due to friction with the fluid.

The zinc block body 40 generates zinc ions by the ion potential difference with the housing 10, and as illustrated in FIGS. 3A to 3C, the zinc block body 40 is provided with the plurality of flow channels 10′ through which the fluid flows.

In addition, the zinc block body 40 may be formed with a structure in which one or more zinc plates 40′ are combined, as illustrated in FIG. 3C. That is, the zinc block body 40 may be formed with a structure in which two or more zinc plates 40′ having the flow channels 10′ are continuously and closely arranged or combined to form one block body.

The flow channels 10′ are arranged so that the plurality of flow channels 10′ is evenly arranged through the zinc block body 40, and like the flow channels 10 of the fluorine resin body, all the flow channels may be formed to have the same inner diameter, or formed so that two types of inner diameters are provided, or formed so that adjacent flow channels have different inner diameters.

In addition, although the inner diameter and volume ratio of the flow channel 10′ of the zinc block body are not specific, it is preferable that the inner diameter and volume rate are formed to be equal to those of the flow channel 10 of the fluorine resin body. That is, it is preferable that the flow channels 10′ of the zinc block body also have the volume ratio of about 1:0.4 to 0.6, and that the plurality of flow channels 10′ is formed so that an inner diameter d′ is about 0.08 (D′) to 0.15 (D′) with respect to a diameter D′ of the zinc block body. For example, the flow channel 10′ may be formed in the range of about 20 to 30 in the zinc block body 40.

The inner diameter and volume ratio of the flow channel 10′ of the zinc block body are intended to increase the rigidity of the zinc block body 40 and the amount of zinc ions and electrons generated in the zinc block body by considering the flow and contact of the fluid according to the relationship with the fluorine resin body 30.

For example, in FIG. 3A and FIG. 3B of the present disclosure, a configuration is illustrated in which a plurality of first flow channels 10a having an inner diameter (ϕ11-22) and a plurality of flow channels 10b having an inner diameter (ϕ9-4) are formed in the zinc block body 40 having a diameter (ϕ85) so that the zinc block body 40 and the flow channel 10′ have a volume ratio of about 1:0.45 to 0.48. In this case, the first inner diameter and the second inner diameter refer to the inner diameter of the flow hole in the flow channel 10′.

In addition, as illustrated in FIGS. 3A to 3C, the zinc block body 40 is provided with one or more O-ring groove 43 so that an O-ring 50 is installed on the outer circumference, and as illustrated in FIG. 1, the zinc block body 40 is installed airtightly (water-tightly) in the housing 10 via the O-ring 50.

In addition, as illustrated in FIGS. 3A and 3B, the zinc block body 40 may further have a fluid inflow space 41 and a fluid outflow space 42. That is, the zinc block body 40 may be configured to include the fluid inflow space 41 where the fluid is inflowed, the fluid outflow space 42 where the fluid is outflowed, and the plurality of flow channels 10′ integrally formed between the fluid inflow space 41 and the fluid outflow space 42 and connected to the fluid inflow space 41 and the fluid outflow space 42.

In addition, when the flow channel 10′ is installed in the housing 20 so as to be located between the fluorine resin bodies 30, the flow channel 10′ may be formed to be provided coaxially with the flow channel 10 of the fluorine resin body or may be formed to be staggered with the flow channel 10 of the fluorine resin body, and is preferably formed to be staggered with the flow channel 10 of the fluorine resin body.

The flow channels 10 and 10′ provided in the fluorine resin body 30 and zinc block body 40 may be configured to include the inlet 11 through which fluid is introduced, the outlet 12 through which fluid is discharged, and the flow hole 13 connecting the inlet 11 and the outlet 12, as illustrated in FIGS. 5 and 6.

The inlet 11 is formed as an expansion pipe portion whose diameter (inner diameter) gradually expands in the direction of the outside A from the flow hole 13, for example, toward the fluid inflow spaces 31 and 41, and the outlet 12 is formed as a reduction pipe portion whose diameter (inner diameter) gradually decreases in the direction of the outside A, for example, from the fluid outflow spaces 32 and 42 toward the flow hole 13, and the outlet 12 and the inlet 11 are provided with one or more eddy current-inducing grooves 14 on their surfaces.

The outlet 12 has a function of controlling the flow rate of the fluid moving in the direction of the outside A from the flow hole 13 to induce the generation of an eddy current, and the inlet 11 has a function of allowing the fluid to quickly flow from the outside A into the flow hole 13 and allowing the fluid inside the flow hole 13 to have a high flow rate.

In addition, the outlet 12 and the inlet 11 may have the same size and shape structure (circular cross-section structure or polygonal cross-section structure) and may be formed connected to the flow hole 13 so as to be symmetrical to each other with the flow hole 13 as the center, or may have different sizes and shape structures (circular cross-section structure or polygonal cross-section structure) and may be formed connected to the flow hole 13. In this case, the outlet 12 and the inlet 11 are formed within a range where interference does not occur between neighboring flow channels.

The eddy current-inducing groove 14 controls the flow rate by friction with the fluid and induces eddy current generation in the fluid, and as illustrated in FIGS. 2A to 6, at least one, preferably two or more, eddy current-inducing grooves may be formed on the surface of the outlet 12 and/or the inlet 11 at a predetermined depth and spaced apart at regular intervals.

For example, the eddy current-inducing grooves 14 may be provided such that about 4 to 8 of the grooves are disposed at regular intervals along the surface periphery of the outlet 12 and/or the inlet 11 so as to be connected to the flow hole 13 and the fluid outflow/inflow spaces 31, 41, 32, and 42. That is, the eddy current-inducing grooves 14 may be formed such that the grooves have a rough structure along the surface periphery of the outlet 12 formed of the expansion pipe portion and/or the inlet 11 formed of the reduction pipe portion and are disposed at regular intervals.

In addition, the eddy current-inducing groove 14 may be formed radially, as illustrated in FIG. 7A, FIG. 8A, and FIG. 8B.

In addition, as illustrated in FIG. 7B, the eddy current-inducing grooves 14 may be formed in an inclined shape in which one end of the eddy current-inducing groove connected to the flow hole and the other end of the eddy current-inducing groove connected to the fluid outlet (or fluid inlet) are connected in an inclined structure so that they are not located in the radial direction.

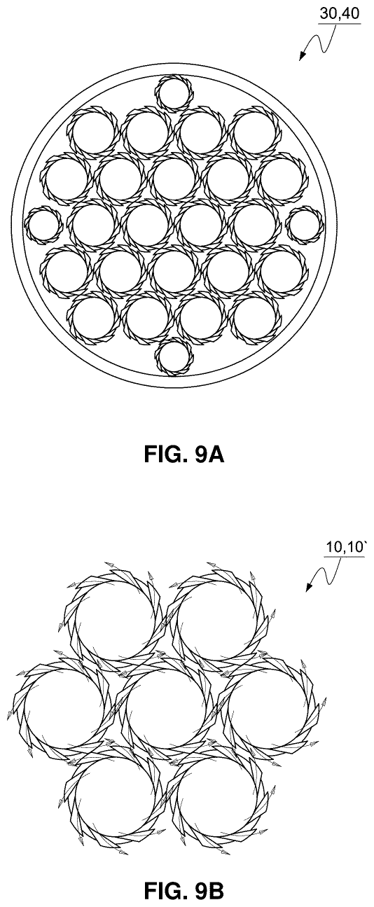

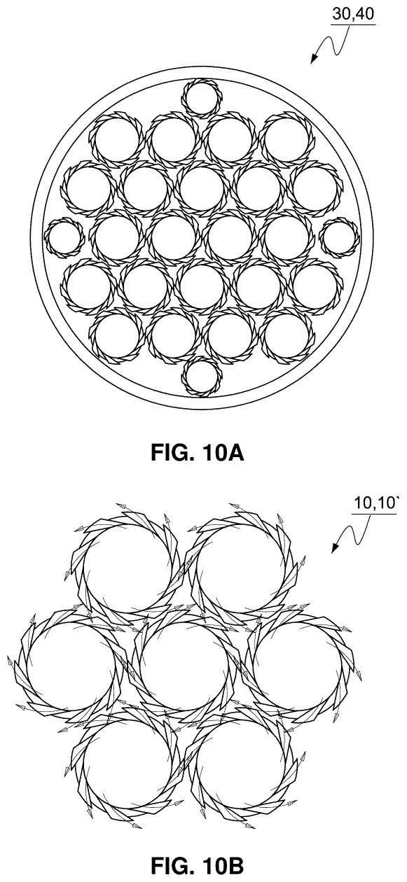

In addition, the eddy current-inducing groove 14 may be formed in a curved shape in which one end of the eddy current-inducing groove that is connected to the flow hole and the other end of the eddy current-inducing groove that is connected to the fluid outlet (or fluid inlet) are connected in a curved structure, as illustrated in FIG. 7C, FIG. 9A, FIG. 9B, FIG. 10A, and FIG. 10B.

In addition, it is preferable that the eddy current-inducing groove 14 is formed in a curved shape, and the curved eddy current-inducing groove 14 may be formed so that the fluid flows in the same direction.

That is, the eddy current-inducing groove 14 may be formed so that the fluid flows along the eddy current-inducing groove 14 in the same direction, for example, counterclockwise or clockwise.

FIG. 9A and FIG. 9B are exemplary diagrams illustrating the arrangement of the eddy current-inducing grooves and the fluid flow thereby according to the present disclosure, and a configuration in which the fluid flows along the eddy current-inducing groove 14 in the same direction is illustrated.

As illustrated in FIG. 9A and FIG. 9B, the fluid flow along the eddy current-inducing groove of one flow panel and the fluid flow along the eddy current-inducing groove of another flow channel adjacent thereto are combined, so that when the fluid moves into the fluid outflow space through the flow hole, there is an effect of a strong eddy current flow due to the change in the fluid flow rate, the shape of the outlet, and the eddy current-inducing groove.

FIG. 10A and FIG. 10B are exemplary views illustrating the arrangement of eddy current-inducing grooves and the fluid flow thereby according to the present disclosure, and the configuration in which the fluid flow is made in the opposite direction by the eddy current-inducing grooves 14 provided in the flow channels 13 disposed in mutually adjacent rows is illustrated.

As illustrated in FIG. 10A and FIG. 10B, in a case where the fluid flow is made in the counterclockwise direction by the eddy current-inducing grooves provided in the flow channel of one row, and the fluid flow is made in the clockwise direction by the eddy current-inducing grooves provided in the flow channel of another row adjacent thereto, when the fluid moves into the fluid outflow space through the flow hole, the effect of maximally increasing the generation of the eddy current is achieved by the change in the fluid flow rate, the shape of the outlet, and the eddy current-inducing grooves.

In addition, as illustrated in FIG. 2C, when the plurality of flow channels is disposed in a circular manner in multiple layers, the eddy current-inducing grooves 14 may be formed so that all of the same fluid flow is formed, or may be formed so that fluid flows that are radially opposite to each other are formed.

The flow hole 13 connects the inlet 11 and the outlet 12, and as illustrated in FIGS. 5 and 6, may be formed so that the same diameter (inner diameter) or cross-sectional area is formed, or may be formed so that the diameter (inner diameter) or cross-sectional area gradually decreases as the flow hole 13 goes from the inlet 11 to the outlet 12.

In addition, the flow hole 13 may be formed in a straight structure (a structure parallel to the longitudinal direction of the housing) from the inlet 11 to the outlet 12, or may be formed in an inclined structure (a structure inclined to the longitudinal direction of the housing) from the inlet 11 to the outlet 12.

In addition, it is preferable that the inlet 11 and outlet 12 and the flow hole 13 are formed to have a length ratio of about 0.1:0.1:0.5 to 1.5. This length ratio is to ensure sufficient length (L) of the flow hole while efficiently generating the eddy current by the inlet 11 and outlet 12 provided with the eddy current-inducing groove 14. That is, when the flow hole deviates from the above length ratio, the fluid flow rate and eddy current generation decrease, thereby lowering the friction and static electricity generation efficiency, so it is preferable that the length ratio is formed within an appropriate range.

In particular, when considering that the outlet 12 and the inlet 11 are formed within a range where interference does not occur between the adjacent flow channels, that is, within a limited narrow range, the length ratio of the inlet 11, the outlet 12, and the flow hole 13 affects the enhancement of eddy current generation, so it is desirable to form the length ratio within an appropriate range.

As illustrated in FIGS. 5 and 6, the flow channels 10 and 10′ configured as above are formed as a venturi tube structure entirely by the inlet 11, the outlet 12, and the flow hole 13, so that when the fluid moves from the fluid inflow spaces 31 and 41 to the fluid supply spaces 32 and 42 via the flow channels 10 and 10′, the generation of the eddy current increases as the fluid velocity changes.

In addition, the fluid flowing into the outlet 12 equipped with the eddy current-inducing groove 14 through the flow hole 13 moves along the eddy current-inducing groove 14 while colliding with the surface of the outlet 12 formed so that the eddy current-inducing groove 14 has a rough structure, thereby intensifying the change in the velocity of the fluid and further enhancing the eddy current.

That is, the fluid flowing into the flow hole 13 through the inlet 11 moves along the longitudinal direction of the flow hole and then moves to the outlet 12 formed with the expansion pipe portion that is expanded more than the circumference of the flow hole 13 and collides with the surface of the outlet equipped with the eddy current-inducing groove 14 at regular intervals, and thus, the direction of the fluid flow changes along the eddy current-inducing groove, thereby forming the eddy current.

In addition, the fluid flowing into the outlet 12 from the flow hole 13 has a reduced velocity as the cross-sectional area (range through which water flows) is expanded, thereby further enhancing the generation of the eddy current.

As described above, the present disclosure has the effect of maximizing the generation of the eddy currents in the fluid passing through the fluorine resin body and the zinc block body in the limited space within the housing, improving the efficiency of static electricity generation by the eddy current generation and efficiently combining zinc ions with ionic substances in the fluid.

In addition, as illustrated in FIGS. 2A to 6, the present disclosure preferably has eddy current-inducing grooves 14 in the outlet 12 and inlet 11 of the flow channel, but as illustrated in

FIGS. 11A and 11B, the outlet may be formed as the expansion pipe portion, and the inlet may be formed as the reduction pipe portion. In other words, the outlet and the inlet may be configured so that the eddy current-inducing grooves are omitted.

FIG. 12A and FIG. 12B are exemplary views illustrating the combined state of the zinc ion water treatment device according to the present disclosure, in which the fluorine resin body and the zinc block body are alternately disposed in the housing, and the fluid flows through the flow channels of the fluorine resin body and the zinc block body. FIG. 12A illustrates a configuration in which the fluorine resin body according to FIG. 2A or FIG. 2B is disposed, and FIG. 12B illustrates a configuration in which the fluorine resin body according to FIG. 2C is disposed.

The present disclosure is not limited to the specific preferred embodiments described above, and anyone with ordinary knowledge in the technical field to which the present disclosure belongs can make various modifications without departing from the gist of the present disclosure claimed in the claims, and such modifications are within the scope of the claims.

In addition, since the terms described in the present disclosure are intended to distinguish one component from another and to help understand the present disclosure, the components of the present disclosure are not limited by the terms described.

What is claimed is:

1. A zinc ion water treatment device (100) in which a plurality of fluorine resin bodies (30) is installed at regular intervals within a housing (20) and a zinc block body (40) is disposed between the fluorine resin bodies (30),
wherein the fluorine resin body (30) and the zinc block body (40) are provided with a plurality of flow channels (10, 10′) through which a fluid flows,
the flow channel (10) of the fluorine resin body or the flow channel (10′) of the zinc block body or the flow channels (10, 10′) of the fluorine resin body and the zinc block body include an inlet (11) through which the fluid is introduced, an outlet (12) through which the fluid is discharged, and a flow hole (13) connecting the inlet and the outlet, and
the inlet (11) is formed as an expansion pipe portion whose diameter (inner diameter) gradually expands in a direction of an outside (A) from the flow hole (13), the outlet (12) is formed as a reduction pipe portion whose diameter (inner diameter) gradually decreases in a direction of the flow hole (13) from the outside (A), and the outlet (12) or the inlet (11) or the outlet (12) and the inlet (11) are provided with one or more eddy current-inducing grooves (14) on a surface, so that when the fluid passes through the flow channel (10), eddy current generation is increased by the inlet (11) and/or the outlet (12) provided with the eddy current-inducing grooves (14).

2. The zinc ion water treatment device of claim 1, wherein the flow channels (10) of the fluorine resin body are formed in multiple numbers so that the flow channels have a volume ratio of 1:0.4 to 0.6 with respect to an entire volume of the fluorine resin body, and an inner diameter (d) of 0.08 (D) to 0.25 (D) with respect to a diameter (D) of the fluorine resin body,
the flow channels (10′) of the zinc block body are formed in multiple numbers so that the flow channels (10′) have a volume ratio of 1:0.4 to 0.6 with respect to an entire volume of the zinc block body, and an inner diameter (d) of 0.08 (D) to 0.25 (D) with respect to a diameter (D) of the zinc block body, and
the inlet (11) and outlet (12) and the flow hole (13) of the flow channels (10, 10′) are formed to have a length ratio of 0.1:0.1:0.5 to 1.5.

3. The zinc ion water treatment device of claim 2, wherein the flow channel (10) of the fluorine resin body and the flow channel (10′) of the zinc block body are formed to be coaxially connected within the housing.

4. The zinc ion water treatment device of claim 2, wherein the flow channel (10) of the fluorine resin body and the flow channel (10′) of the zinc block body are formed to be staggered with each other within the housing.

5. The zinc ion water treatment device of claim 1, wherein the eddy current-inducing groove (14) is radially or obliquely formed.

6. The zinc ion water treatment device of claim 1, wherein the eddy current-inducing groove (14) is formed in a curved structure and all eddy current-inducing grooves provided in the flow channel have the same structure.

7. The zinc ion water treatment device of claim 1, wherein the eddy current-inducing groove (14) is formed in a curved structure and the eddy current-inducing groove provided in one flow channel and the eddy current-inducing groove provided in another flow channel adjacent thereto are formed so that the fluid flows in opposite directions.

8. The zinc ion water treatment device of claim 1, wherein the fluorine resin body (30) is configured such that a fluid inflow space (31) is provided on one side and a fluid outflow space (32) is provided on the other side with the fluid channel (10) as the center, and the fluid inflow space (31) and the fluid outflow space (32) are connected to each other by the fluid channel (10), and
the zinc block body (40) is configured to include a fluid inflow space (41) where the fluid is introduced, a fluid outflow space (42) where the fluid is outflowed, and a plurality of fluid channels (10′) integrally formed between the fluid inflow space (41) and the fluid outflow space (42) and connected to the fluid inflow space (41) and the fluid outflow space (42).

9. The zinc ion water treatment device of claim 1, wherein the housing is formed as a heterogeneous composite tube structure with an inner housing made of stainless steel (SUS) material inside an outer housing made of brass material.
